(19) United States
(12) Patent Application Publication
(10) Pub. No.: US 2025/0348579 A1
(43) Pub. Date: Nov. 13, 2025

(54) Automated Discovery of Behavioral Threat Protection Rules

(71) Applicant: Palo Alto Networks (Israel Analytics) Ltd., Tel Aviv (IL)

(72) Inventors: Lior Perry, Beer Sheva (IL); Guy Holdengreber, Tel Aviv (IL); Yohan Hai Guez, Tel-Aviv (IL)

(21) Appl. No.: 18/661,626

(22) Filed: May 12, 2024

(51) Int. Cl. G06F 21/55; G06F 17/16

(52) U.S. Cl. CPC G06F 21/552; G06F 17/16; G06F 2221/033

(57) ABSTRACT

A method for producing threat detection rules includes obtaining a set of one or more threat detection rules, wherein each threat detection rule in the set indicates, when applied to a process running in a computer, whether the process is benign or malicious based on a respective group of one or more features selected from a defined list of features. A series of iterations that expand the set is executed, by (i) selecting, from the set, a threat detection rule that meets a selection criterion, (ii) generating one or more expanded threat detection rules, by adding one or more additional features from the list to the selected threat detection rule, and (iii) adding the one or more expanded threat detection rules to the set. Following the series of iterations, the expanded set of threat detection rules is output.

### FIELD OF THE INVENTION

The present invention relates generally to cyber security, and particularly to methods and systems for automated discovery of Behavioral Threat Protection (BTP) rules and other threat detection rules.

### BACKGROUND OF THE INVENTION

Various techniques for detecting and mitigating malware attacks in computers are known in the art. Some techniques attempt to learn the typical characteristics of an attack, and to formulate rules that distinguish between benign and malicious events. Techniques of this sort are described, for example, in “AutoCombo: Automatic Malware Signature Generation Combination Rule Mining,” Du et al., Proceedings of the 30^{th} ACM International Conference on Information and Knowledge Management (CIKM), Queensland, Australia, November 2021.

### SUMMARY OF THE INVENTION

An embodiment of the present invention that is described herein provides a method for producing threat detection rules. The method includes obtaining a set of one or more threat detection rules, wherein each threat detection rule in the set indicates, when applied to a process running in a computer, whether the process is benign or malicious based on a respective group of one or more features selected from a defined list of features. A series of iterations that expand the set is executed, by (i) selecting, from the set, a threat detection rule that meets a selection criterion, (ii) generating one or more expanded threat detection rules, by adding one or more additional features from the list to the selected threat detection rule, and (iii) adding the one or more expanded threat detection rules to the set. Following the series of iterations, the expanded set of threat detection rules is output.

In some embodiments, the method further includes protecting one or more computers by applying the expanded set of threat detection rules to one or more processes running in the one or more computers. In a disclosed embodiment, the selection criterion requires that the selected threat detection rule (i) was not previously expanded, and (ii) has at least a minimal required quality. In an embodiment, expanding the set includes evaluating a quality of each expanded threat detection rule, and recording the quality in the expanded set of threat detection rules.

In some embodiments, expanding the set includes performing a matrix computation that jointly calculates precision and coverage values of multiple possible expansions of a given threat detection rule with respect to a training set. In an example embodiment, a given entry of the training set is derived from one or more executions of one or more processes and includes (i) a subset of the features that were found in the executions and (ii) a label indicating whether the executions are benign or malicious.

In an example embodiment, performing the matrix computation includes: generating (i) a first binary matrix whose rows represent one or more entries of the training set labeled as benign and (ii) a second binary matrix whose rows represent one or more entries of the training set labeled as malicious, wherein in both the first and second binary matrices (i) columns represent the features and (ii) a matrix element is set to “1” when the corresponding feature is found in the corresponding entry, and to “0” otherwise; and deriving the precision and coverage values of the multiple possible expansions from the first and second binary matrices.

There is additionally provided, in accordance with an embodiment of the present invention, a system for producing threat detection rules. The system includes a memory and a processor. The memory is configured to store a set of one or more threat detection rules, wherein each threat detection rule in the set indicates, when applied to a process running in a computer, whether the process is benign or malicious based on a respective group of one or more features selected from a d defined list of features. The processor is configured to execute a series of iterations that expand the set by (i) selecting, from the set, a threat detection rule that meets a selection criterion, (ii) generating one or more expanded threat detection rules, by adding one or more additional features from the list to the selected threat detection rule, and (iii) adding the one or more expanded threat detection rules to the set. Following the series of iterations, the processor is configured to output the expanded set of threat detection rules.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for automated discovery of Behavioral Threat Protection (BTP) rules, in accordance with an embodiment of the present invention;

FIG. 2 is a diagram that schematically illustrates an example of a BTP rule evaluated over a training dataset, in accordance with an embodiment of the present invention;

FIG. 3 is a flow chart that schematically illustrates a method for automated discovery of Behavioral Threat Protection (BTP) rules, in accordance with an embodiment of the present invention;

FIG. 4 is a diagram that schematically illustrates an iteration in the method of FIG. 3, in accordance with an embodiment of the present invention; and

FIG. 5 is a diagram that schematically illustrates efficient, matrix-based process for evaluating an candidate BTP rules, in accordance with an embodiment of the present invention.

### DETAILED DESCRIPTION OF EMBODIMENTS

### Overview

A computer typically runs multiple software processes at any given time. Processes may belong to a user application, to the computer's operating system, or to any other software. Normally, most processes are benign, but some processes may be malicious, i.e., associated with malware or other threat. To properly protect the computer, it is important to distinguish between benign and malicious processes with high speed and accuracy.

Embodiments of the present invention that are described herein provide improved techniques for distinguishing between benign and malicious processes. The embodiments described herein refer mainly to Behavioral Threat Protection (BTP) rules, by way of example. The disclosed techniques, however, are not limited to BTP and can be used for generating and evaluating any other suitable type of threat detection rules.

In BTP, a given process is checked against a list of predefined features. Features may comprise, for example, properties of a file associated with the process, the type of process, properties of a network protocol associated with the process, and many others. Certain combinations of features are considered characteristic of malicious processes.

A “BTP rule” is a rule that specifies a particular combination of features that, when occurring in a process, indicates with high accuracy that the process is malicious. To evaluate a given process, the process typically needs to be checked against a large set of BTP rules that test many combinations of features drawn from a long list of features.

In some embodiments of the present invention, a BTP rule discovery system assists a human operator, e.g., an analyst, in generating and evaluating candidate BTP rules.

The system uses a labeled training dataset, typically prepared in advance, for generating and evaluating candidate BTP rules. The training dataset comprises multiple entries. Each entry is derived from monitored execution of one or more processes and comprises (i) the subset of features found in the processes, and (ii) a label indicating whether the processes are malicious or benign.

In some embodiments, at least some of the entries in the training dataset represent “causalities” rather than individual processes. In the present context, the term “causality” refers to a group of processes that includes (i) a “parent” process and (ii) one or more processes that were triggered, directly or indirectly, by the parent process. In other words, the term “causality” refers jointly to a certain process and its direct and indirect child processes. The description herein uses the terms “process”, “causality” and “execution” interchangeably.

In some embodiments, the system runs an iterative method that discovers new BTP rules. The method begins with an initial set of one or more BTP rules, and attempts to expand them in a manner that improves their quality. The method iteratively expands the existing BTP rules in the set by adding features to the existing rules, evaluates the quality of the expanded rules, and adds the expanded rules to the set.

In an example implementation, the system begins with the set of all possible single-feature rules, and evaluates their precision and coverage with respect to the training dataset. Then, in each iteration, the system selects the N best rules in the set that were not expanded yet. The system derives a plurality of expanded rules from each of the N selected rules, each expanded rule comprising the selected rule plus one added feature. The system evaluates the precision and coverage of the expanded rules and adds them to the set of BTP rules. The iterative method typically continues until a defined termination condition is met, e.g., until completing a predetermined number of iterations or until no additional rules can be expanded. The system then typically filters-out rules having insufficient quality, selects a set of minimal number of BTP rules which have maximum joint precision and coverage while maintaining minimal mutual overlap, and outputs the resulting set of BTP rules.

The main computational bottleneck of the above iterative method is the task of evaluating the precision and coverage of each candidate (expanded) BTP rule over the training dataset. In some embodiments, the system uses an efficient matrix-based computation that simultaneously calculates the precision and coverage of multiple (e.g., all) possible expansions of a certain BTP rule.

The disclosed techniques are highly effective in discovering new BTP rules having high precision and coverage. In comparison with Machine-Learning (ML) based techniques, the disclosed methods are considerably more transparent as to the features and criteria they use for rule selection, and therefore produce rules having better explainability.

The disclosed techniques can be used with various levels of involvement of a human operator. In one use-case, the iterative method runs entirely automatically to produce the best possible set of BTP rules for a given list of features. In another use-case, an analyst may formulate a single BTP rule, and the system attempts to improve it by testing various expansions.

### System Description

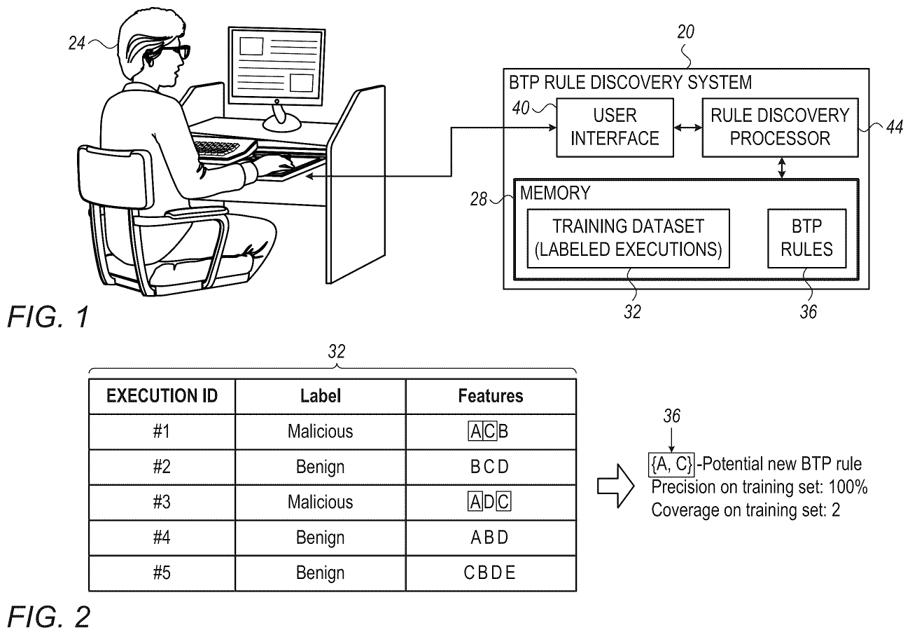

FIG. 1 is a block diagram that schematically illustrates a system 20 that assists a human operator 24, e.g., an analyst, in automated discovery of Behavioral Threat Protection (BTP) rules, in accordance with an embodiment of the present invention. System 20 comprises a memory 28 that stores a training dataset 32 and a set of BTP rules 36. System 20 further comprises a user interface 40, e.g., a display, keyboard and/or mouse, for interacting with operator 24, and a rule discovery processor 44 that carries out the methods described herein.

The configuration of system 20 shown in FIG. 1 is an example configuration, which is chosen purely for the sake of conceptual clarity. In alternative embodiments, any other suitable configuration can be used. Elements that are not necessary for understanding the principles of the present invention have been omitted from the figures for clarity.

The various elements of system 20 may be implemented in hardware, e.g., in one or more Application-Specific Integrated Circuits (ASICs) or FPGAs, in software, or using a combination of hardware and software elements. Memory 28 may any suitable type of memory, e.g., Random-Access Memory (RAM).

Typically, processor 44 comprises a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Iterative Discovery of Btp Rules

FIG. 2 is a diagram that schematically illustrates an example of a BTP rule evaluated using a training dataset, in accordance with an embodiment of the present invention.

The left-hand side of the figure shows a simple example of training dataset 32 comprising five entries. Each entry represents a respective execution. The execution represented by a given entry may comprise an individual process or a causality (a root process plus one or more dependent processes triggered by it). Each entry specifies (i) one or more features (out of a list of features denoted A, B, C, D, E, F, . . . ) found in the respective execution, and (ii) a label indicating whether the execution is malicious or benign.

Training dataset 32 may be obtained in any suitable manner, e.g., by recording, analyzing and labeling actual executions on multiple computers.

The list of features (A, B, C, D, E, F, . . . ) may comprise any suitable type of feature that, alone or in combination with other features, may be correlative to malicious operations. Some examples of features include, but are in no way limited to, the following list. In the list below, the term “actor process” refers to a process that generated the event in question.

### Process Features:

Process runs from a temporary folder—The path of the binary backing the actor process is in a temporary folder.
Process runs from a file having a double extension—The filename of the binary backing the actor process has a double extension (for example FILE.doc.exe)
Process runs from a file having a long path—The filename of the binary backing the actor process is longer than a defined length.
Process is a script—The path or filename of the binary backing the actor process is a scripting engine (e.g., python.exe, cmd.exe, powershell.exe) or the command line contains a script file (e.g., .py,.bat,.ps1)
Process runs in a browser—The path or filename of the binary backing the actor process is a browser (e.g., chrome. exe, firefox.exe).
Process runs in a hidden powershell—The command line of the actor process contains powershell.exe and the—WindowStyle hidden flag.

### File Features:

Drop PE—The actor process wrote a Portable Executable (PE) file to the disk (e.g., exe, dll, sys).
Renamed file to PE—The actor process renamed a non-PE file to a PE extension.
Writing to system folders—The actor process wrote a file to a system folder (for example c:\windows\system32).
Modification of important system files—The actor process modified a system file defined as important (for example the hosts file).

### Network Features:

Communication via protocol—The actor process communicated via a specific network protocol (e.g., http, smb, ftp).
Connection to TOR host—The actor process communicated with a host that is part of the TOR network.

### Registry Features:

Service modification—The actor process modified the registry key of a service.
Persistence—The actor process modified a well-known registry key that allows running a binary at startup.

### RPC Features:

RPC Call—The actor process ran a Remote Procedure Call (RPC) call.

Many of the features listed above have two types—(i) an aggregate feature (the headings) and (ii) a specific feature (the examples). For example, if a Chrome process drops a PE file then the features that may be generated are ACTOR_DROP_PE, ACTOR_IS_BROWSER, ACTOR_IS_CHROME.

The features listed above are chosen purely by way of example. In alternative embodiments, any other suitable features can be used. Turning back to FIG. 2, the right-hand side of the figure shows a potential BTP rule 36, in the present example [A, C]. This BTP rule, when applied to a certain process, decides that the process is malicious if both features A and C are found in the process (possibly in combination with other features).

In some embodiments, processor 44 evaluates the quality of a potential rule 36 by calculating the precision and the coverage of the rule in training dataset 32. In the present context, the term “coverage of a rule” means the number of entries of training dataset 32 that contain the combination of features specified by the rule. The term “precision of a rule” means the percentage of the entries that (i) contain the combination of features specified by the rule and (ii) are labeled as malicious.

Generally speaking, the coverage of a rule is indicative of how rarely or frequently the rule is likely to be triggered. The precision of a rule is indicative of the probability of false alarm (false-positive probability) of the rule, i.e., the likelihood of a benign process triggering the rule erroneously. A high-quality rule will generally have both high coverage and high precision, where precision is typically of higher priority than coverage. The embodiments described herein refer to precision and coverage as quality metrics. Alternatively, however, processor 44 may use any other suitable metrics for evaluating the quality of potential BTP rules.

In the example of FIG. 2, the combination of features A and C appears in two entries (#1 and #3), therefore Coverage=2. Both of these entries are labeled as malicious, therefore Precision=100%.

The dataset and BTP rule shown in FIG. 2 are highly simplified examples that are chosen purely for the sake of conceptual clarity. A real-life training dataset will typically contain a large number of entries, e.g., on the order of 10,000, and the dataset and rules will typically refer to a large number of features, e.g., on the order of 400 or more. The number of BTP rules in such a system may be on the order of 10,000 or more.

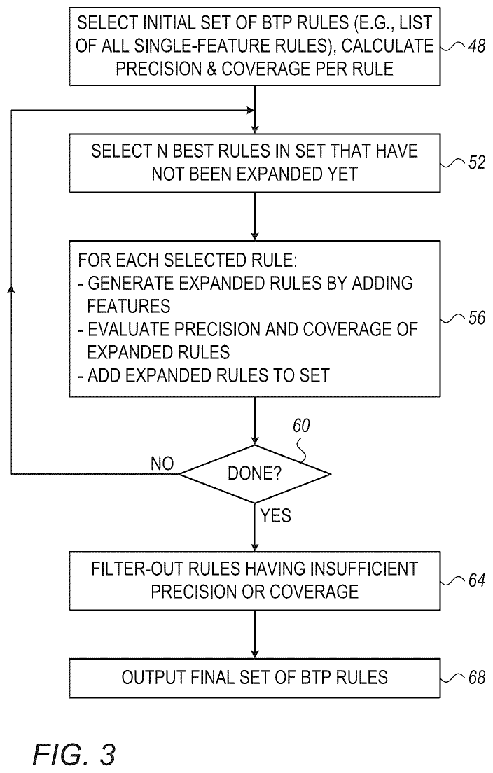

FIG. 3 is a flow chart that schematically illustrates a method for automated discovery of BTP rules, in accordance with an embodiment of the present invention. The method begins with processor 44 of system 20 initializing the set of BTP rules 36 to a certain initial set, at an initialization operation 48. In one example, the initial set is a set of all possible single-feature rules ([A], [B], [C], [D], . . . ). Alternatively, any other suitable initial set can be used. Processor 44 calculates the precision and coverage of each rule in the initial set.

At a selection operation 52, processor 44 selects the N best rules in BTP rule set 36 that have not been expanded yet. N is a predefined integer. Various selection criteria can be used for this purpose. In an example embodiment, from among the rules that were not expanded yet, processor 44 selects the N rules having the highest precision. In necessary, processor 44 uses the coverage of the rules as a secondary “tiebreaker”—A criterion to choose between rules having the same precision.

At an expansion operation 56, processor 44 expands each of the N selected rules. In the expansion operation, processor 44 generates multiple expanded rules from each of the N selected BTP rules. Each expanded rule comprises the selected rule plus a single feature. For example, the rule [A, C] is expanded to form the expanded rules [A, C, B], [A, C, D], [A, C, E], [A, C, F], . . . and the rule [A, E] is expanded to form the expanded rules [A, E, B], [A, E, C], [A, E, D], [A, E, F], . . . . Processor 44 calculates the precision and coverage of each expanded rule, and adds the new expanded rules along with their precision and coverage values to the set of BTP rules 36.

At a termination checking operation 60, processor 44 checks whether the rule discovery method is completed. As noted above, various termination conditions can be used, e. g., checking whether a predetermined number of iterations has been completed, or whether no additional rules can be expanded.

If the termination condition is not met, the method loops back to operation 52 above in which processor 44 begins to perform the next iteration. If the rule discovery is completed, processor 44 filters-out one or more of the BTP rules in set 36 that have insufficient quality, at a filtering operation 64. Filtering typically means discarding rules whose precision falls below a defined precision threshold (e.g., <85%) and whose coverage falls below a defined coverage threshold (e.g., less than ten samples).

In some embodiments, after the filtering stage, processor 44 selects a subset of the BTP rules having (i) maximal precision and coverage and (ii) minimal mutual overlap. The permitted amount of overlap between a pair of rules can be configurable.

The remaining set 36 of BTP rules is then provided as output, at an output operation 68. The resulting set of BTP rules can be used for protecting any suitable computer system comprising one or more computers, by applying the BTP rules in the set to one or more processes running in the one or more computers.

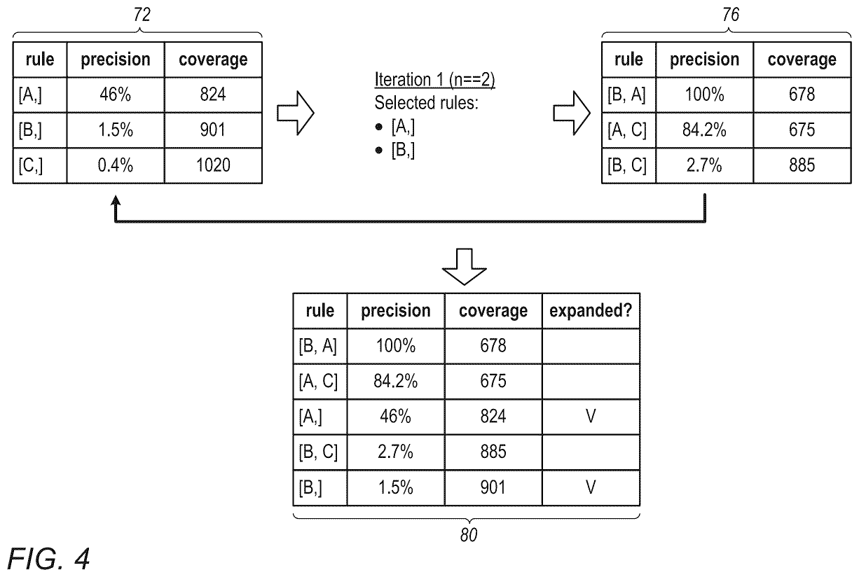

FIG. 4 is a diagram that schematically illustrates the first iteration in the method of FIG. 3, in accordance with an embodiment of the present invention. A table 72 at the top-left of the figure shows the state of BTP rule set 36 at the beginning of the iteration (following operation 48 of FIG. 3). At this stage, set 36 comprises three single-feature rules, each having a certain precision and coverage with respect to training dataset 32.

In the example of FIG. 4, processor 44 selects the two best rules for expansion (i.e., N=2). Therefore, the selected rules (selected at stage 52 of FIG. 3) are [A,] and [B,], which have much better precisions than the rule [C,]. A table 76 at the top-right of the figure shows the expanded BTP rules generated from the two selected rules. As seen, the expansion operation (part of operation 56 of FIG. 3) yields three expanded rules.

A table 80 at the bottom of the figure shows the state of BTP rule set 36 after adding the expanded rules to the set (following operation 56 of FIG. 3). For each rule, BTP rule set 36 specifies the rule's precision and coverage, and an indication of whether the rule was previously expanded or not.

Subsequent iterations of the method are performed in a similar manner.

### Computationally-Efficient Evaluation of Candidate Btp Rules

In practical implementations, the runtime required by the disclosed rule discovery method is a limiting factor in discovering high quality BTP rules. The most computationally intensive part of the method is the calculation of the precision and coverage of the various candidate BTP rules. This calculation is especially time consuming when the number of features and the number of entries in the training dataset are large.

In some embodiments, processor 44 of system 20 reduces runtime considerably by performing a matrix-based computation that jointly calculates the precision and coverage of multiple (e.g., all) possible expansions of a certain BTP rule. This computation can be used, for example, for implementing stage 56 of the method of FIG. 3 above.

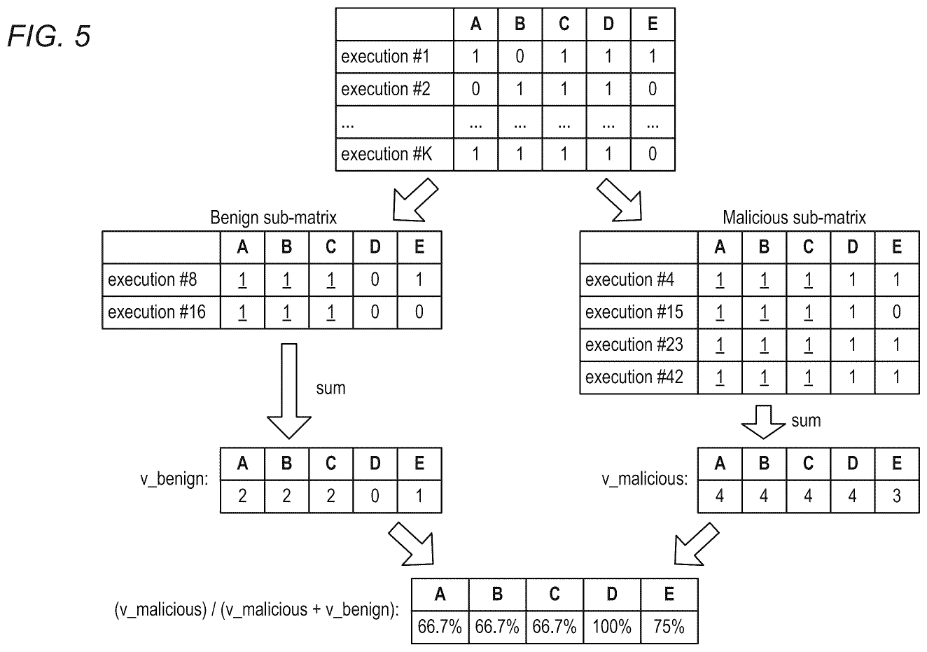

FIG. 5 is a diagram that schematically illustrates an efficient, matrix-based process for evaluating candidate BTP rules, in accordance with an embodiment of the present invention. The process begins with processor 44 constructing a pair of binary matrices referred to as a “Benign matrix” and a “Malicious matrix”.

In each of the two matrices, rows correspond to respective executions in training dataset 32, and columns correspond to respective features. The Benign matrix comprises the executions that are labeled benign, and the Malicious matrix comprises the executions that are labeled malicious.

In both matrices, each matrix element is associated with a certain execution (row) and with a certain feature (column). The matrices are constructed such that a matrix element is set to “1” if the corresponding feature is found in the corresponding execution, and to “0” otherwise.

This stage of the process may be performed in advance, as a preparatory step that is not specific to any particular BTP rule. Processor 44 may save the benign matrix and the malicious matrix, e.g., in memory 28, for use in evaluating any desired candidate BTP rule. The process from this point onwards is typically performed for a specific candidate BTP rule to be evaluated.

In order to evaluate the various possible expansions of a given candidate BTP rule, processor 44 filters the rows of the benign matrix and the malicious matrix to produce two sub-matrices referred to as a “benign sub-matrix” and a “malicious sub-matrix”, respectively.

The benign sub-matrix comprises the rows of the benign matrix in which all the features of the BTP rule appear (i.e., the rows in which all the elements corresponding to the features of the BTP rule are “1”). In other words, the benign sub-matrix represents the executions in dataset 32 that (i) meet the BTP rule and (ii) are labeled as benign.

Similarly, the malicious sub-matrix comprises the rows of the malicious matrix in which all the features of the BTP rule appear (i.e., the rows in which all the elements corresponding to the features of the BTP rule are “1”). The malicious sub-matrix thus represents the executions in dataset 32 that (i) meet the BTP rule and (ii) are labeled as malicious.

The example of FIG. 5 demonstrates evaluation of the BTP rule [A, B, C]. Therefore, the benign sub-matrix comprises the rows of the benign matrix in which the element corresponding to feature A, the element corresponding to feature B, and the element corresponding to feature C, are equal to “1”. The malicious sub-matrix comprises the rows of the malicious matrix in which the element corresponding to feature A, the element corresponding to feature B, and the element corresponding to feature C, are equal to “1”.

More formally, the filtering operation performed by processor 44 in this example can be written as matrix[,: A]==1) & (matrix[,: B]==1) & (matrix[,: C]==1).

Processor 44 then sums the rows of the benign sub-matrix to produce a vector denoted “v_benign”. Each element of the v_benign vector corresponds to a certain feature, and its value is equal to the number of executions in training dataset 32 that (i) meet the BTP rule, (ii) contain the corresponding feature, and (iii) are labeled as benign. In the scenario of FIG. 5, for example, feature “D” does not appear in any of the benign executions that meet the BTP rule, and feature “E” appears in one benign execution in dataset 32 that meets the BTP rule.

In a similar manner, processor 44 sums the rows of the malicious sub-matrix to produce a vector denoted “v_malicious”. Each element of the v_malicious vector corresponds to a certain feature, and its value is equal to the number of executions in training dataset 32 that (i) meet the BTP rule, (ii) contain the corresponding feature, and (iii) are labeled as malicious. In the example of FIG. 5, feature “D” appears in four malicious executions that meet the BTP rule, whereas feature “E” appears in three of the malicious executions that meet the BTP rule.

Processor 44 now calculates a vector denoted “precision vector” that is given by (v_malicious/(v_malicious+v_benign). The summation and division operations in this expression denote element-by-element operations. Each element in the resulting precision vector gives the precision of the corresponding feature, if the feature in question were to be used to expand the BTP rule. Referring to the example of FIG. 5, the “D” element of the precision vector gives the precision (100% in this example) of the expansion [A, B, C, D] of the rule [A, B, C], whereas the “E” element of the precision vector gives the precision (75% in this example) of the expansion [A, B, C, E] of the rule [A, B, C].

In this manner, processor 44 simultaneously calculates the precisions of multiple (e.g., all) possible expansions of a given BTP rule.

Processor 44 can also simultaneously calculate the coverage values of the possible expansions—The coverage values are given by the elements of vector v_malicious. Referring to the example of FIG. 5, the “D” element of the v_malicious vector gives the coverage of the expansion [A, B, C, D] of the rule [A, B, C] (coverage=4 in the present example). The “E” element of the v_malicious vector gives the coverage of the expansion [A, B, C, E] of the rule [A, B, C] (coverage=3 in the present example).

Although the embodiments described herein mainly address generation of BTP rules, the methods and systems described herein can also be used in other security-related applications, such as for generation of shellcode detection rules. Moreover, the disclosed techniques are not limited to security, and can be used in various other domains, e.g., for inferring classification rules in medical systems, recommendation systems and many others.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for producing threat detection rules, the method comprising:
obtaining a set of one or more threat detection rules, wherein each threat detection rule in the set indicates, when applied to a process running in a computer, whether the process is benign or malicious based on a respective group of one or more features selected from a defined list of features;
executing a series of iterations that expand the set by:
selecting, from the set, a threat detection rule that meets a selection criterion;
generating one or more expanded threat detection rules, by adding one or more additional features from the list to the selected threat detection rule; and
adding the one or more expanded threat detection rules to the set; and
following the series of iterations, outputting the expanded set of threat detection rules.

2. The method according to claim 1, and comprising protecting one or more computers by applying the expanded set of threat detection rules to one or more processes running in the one or more computers.

3. The method according to claim 1, wherein the selection criterion requires that the selected threat detection rule (i) was not previously expanded, and (ii) has at least a minimal required quality.

4. The method according to claim 1, wherein expanding the set comprises evaluating a quality of each expanded threat detection rule, and recording the quality in the expanded set of threat detection rules.

5. The method according to claim 1, wherein expanding the set comprises performing a matrix computation that jointly calculates precision and coverage values of multiple possible expansions of a given threat detection rule with respect to a training set.

6. The method according to claim 5, wherein a given entry of the training set is derived from one or more executions of one or more processes and comprises (i) a subset of the features that were found in the executions and (ii) a label indicating whether the executions are benign or malicious.

7. The method according to claim 5, wherein performing the matrix computation comprises:
generating (i) a first binary matrix whose rows represent one or more entries of the training set labeled as benign and (ii) a second binary matrix whose rows represent one or more entries of the training set labeled as malicious, wherein in both the first and second binary matrices (i) columns represent the features and (ii) a matrix element is set to “1” when the corresponding feature is found in the corresponding entry, and to “0” otherwise; and
deriving the precision and coverage values of the multiple possible expansions from the first and second binary matrices.

8. A system for producing threat detection rules, the system comprising:
a memory, configured to store a set of one or more threat detection rules, wherein each threat detection rule in the set indicates, when applied to a process running in a computer, whether the process is benign or malicious based on a respective group of one or more features selected from a defined list of features; and
a processor, configured to:
execute a series of iterations that expand the set by (i) selecting, from the set, a threat detection rule that meets a selection criterion, (ii) generating one or more expanded threat detection rules, by adding one or more additional features from the list to the selected threat detection rule, and (iii) adding the one or more expanded threat detection rules to the set; and
following the series of iterations, output the expanded set of threat detection rules.

9. The system according to claim 8, wherein the selection criterion requires that the selected threat detection rule (i) was not previously expanded, and (ii) has at least a minimal required quality.

10. The system according to claim 8, wherein the processor is configured to evaluate a quality of each expanded threat detection rule, and to record the quality in the expanded set of threat detection rules.

11. The system according to claim expanding the set, the processor is configured to perform a matrix computation that jointly calculates precision and coverage values of multiple possible expansions of a given threat detection rule with respect to a training set.

12. The system according to claim 11, wherein a given entry of the training set is derived from one or more executions of one or more processes and comprises (i) a subset of the features that were found in the executions and (ii) a label indicating whether the executions are benign or malicious.

13. The system according to claim 11, wherein the processor is configured to perform the matrix computation by:
generating (i) a first binary matrix whose rows represent one or more entries of the training set labeled as benign and (ii) a second binary matrix whose rows represent one or more entries of the training set labeled as malicious, wherein in both the first and second binary matrices (i) columns represent the features and (ii) a matrix element is set to “1” when the corresponding feature is found in the corresponding entry, and to “0” otherwise; and
deriving the precision and coverage values of the multiple possible expansions from the first and second binary matrices.
